(19) United States
(12) Patent Application Publication
(10) Pub. No.: US 2017/0073566 A1
(43) Pub. Date: Mar. 16, 2017

(54) INVERT EMULSION DRILLING FLUID CONTAINING AN INTERNAL PHASE OF A POLYOL AND SALT-WATER SOLUTION

(71) Applicant: Halliburton Energy Services, Inc., Houston, TX (US)

(72) Inventor: Kenneth W. Pober, Houston, TX (US)

(21) Appl. No.: 15/310,718

(22) PCT Filed: Jun. 4, 2014
(86) PCT No.: PCT/US2014/040810

§ 371 Date: Nov. 11, 2016

(51) Int. Cl. C09K 8/36; E21B 21/00

(52) U.S. Cl. CPC C09K 8/36; E21B 21/00; E21B 21/062

(57) ABSTRACT

An invert emulsion drilling fluid comprising: an external phase, wherein the external phase comprises a hydrocarbon liquid; an internal phase, wherein the internal phase comprises: (i) a polyol; and (ii) a solution comprising a water-soluble salt and water. A method of using the invert emulsion drilling fluid comprises: introducing the drilling fluid into at least a portion of a subterranean formation.

### TECHNICAL FIELD

Invert emulsion drilling fluids can be used for drilling into a water-sensitive subterranean formation. The internal phase of the invert emulsion drilling fluid can have a lower activity, which can cause less adverse effects on the formation.

### DETAILED DESCRIPTION

As used herein, the words “comprise,” “have,” “include,” and all grammatical variations thereof are each intended to have an open, non-limiting meaning that does not exclude additional elements or steps.

As used herein, a “fluid” is a substance having a continuous phase that can flow and conform to the outline of its container when the substance is tested at a temperature of 71° F. (22° C.) and a pressure of one atmosphere “atm” (0.1 megapascals “MPa”). A fluid can be a liquid or gas. A homogenous fluid has only one phase; whereas a heterogeneous fluid has more than one distinct phase. A colloid is an example of a heterogeneous fluid. A heterogeneous fluid can be: a slurry, which includes a continuous liquid phase and undissolved solid particles as the dispersed phase; an emulsion, which includes a continuous liquid phase and at least one dispersed phase of immiscible liquid droplets; or a foam, which includes a continuous liquid phase and a gas as the dispersed phase. As used herein, the term “emulsion” means a heterogeneous fluid in which an aqueous liquid is the continuous (or external) phase and a hydrocarbon liquid is the dispersed (or internal) phase. As used herein, the term “invert emulsion” means a heterogeneous fluid in which a hydrocarbon liquid is the external phase. Of course, there can be more than one internal phase of the emulsion or invert emulsion, but only one external phase. For example, there can be an external phase which is adjacent to a first internal phase, and the first internal phase can be adjacent to a second internal phase. Any of the phases of an emulsion or invert emulsion can contain dissolved materials and/or undissolved solids.

Oil and gas hydrocarbons are naturally occurring in some subterranean formations. In the oil and gas industry, a subterranean formation containing oil or gas is referred to as a reservoir. A reservoir may be located under land or off shore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from the wellbore is called a reservoir fluid.

A well can include, without limitation, an oil, gas, or water production well, or an injection well. As used herein, a “well” includes at least one wellbore. The wellbore is drilled into a subterranean formation. The subterranean formation can be a part of a reservoir or adjacent to a reservoir. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered the region within approximately 100 feet radially of the wellbore. As used herein, “into a well” means and includes into any portion of the well, including into the wellbore or into the near-wellbore region via the wellbore.

A portion of a wellbore may be an open hole or cased hole. In an open-hole wellbore portion, a tubing string may be placed into the wellbore. The tubing string allows fluids to be introduced into or flowed from a remote portion of the wellbore. In a cased-hole wellbore portion, a casing is placed into the wellbore, which can also contain a tubing string. A wellbore can contain an annulus. Examples of an annulus include, but are not limited to: the space between the wall of the wellbore and the outside of a tubing string in an open-hole wellbore; the space between the wall of the wellbore and the outside of a casing in a cased-hole wellbore; and the space between the inside of a casing and the outside of a tubing string in a cased-hole wellbore.

A wellbore is formed using a drill bit. A drill string can be used to aid the drill bit in drilling through a subterranean formation to form the wellbore. The drill string can include a drilling pipe. During drilling operations, a drilling fluid, sometimes referred to as a drilling mud, may be circulated downwardly through the drilling pipe, and back up the annulus between the wellbore and the outside of the drilling pipe. The drilling fluid performs various functions, such as cooling the drill bit, maintaining the desired pressure in the well, and carrying drill cuttings upwardly through the annulus between the wellbore and the drilling pipe.

Some subterranean formations can be adversely affected by certain types of drilling fluids. One example of such a formation is a water-sensitive formation. When a drilling fluid contains water, and the water comes in contact with a water-sensitive formation, the water can adversely affect the subterranean formation. Some of the adverse effects can include swelling or sloughing of the subterranean formation, or gumbo formation.

An example of a water-sensitive formation is a shale formation. Shale formations are different from other types of formations, and there are even differences between individual shale formations. Typically, no two shale formations are the same. Therefore, finding ways to explore and develop shale gas from these formations is a challenge. However, exploration and production of shale gas as an alternative to natural gas produced from “traditional formations” continues to receive increased interest due to the vast quantity of unproduced shale gas around the world, and especially in North America. For example, it is estimated that there is over 3 trillion cubic feet (Tcf) of shale gas in North America alone that is available for production.

In order to help minimize some of the adverse effects water can have on a water-sensitive formation; an invert emulsion drilling fluid typically contains an internal phase of an aqueous solution of salt. The salt-water solution can accomplish several goals, including, lowering the activity of the internal phase of the emulsion, maintaining a sufficient hydrostatic pressure in the wellbore, and binding of the water molecules included in the internal phase.

Activity refers to the vapor pressure of water molecules in an aqueous solution compared with that of pure water. Activity is expressed mathematically as the ratio of two vapor pressures as follows: a_{w}=p/pₒ, where p is the vapor pressure of the solution and p, is the vapor pressure of pure water. By increasing the concentration of salt (or other solutes) in the solution, a_{w} decreases, because the vapor pressure of the solution decreases.

Hydrostatic pressure means the force per unit area exerted by a column of fluid at rest. Two factors that can affect the hydrostatic pressure are the density of the fluid and the depth of the fluid below the earth's surface or the surface of a body of water. Hydrostatic pressure can be calculated using the equation: P=MW*depth*0.052, where MW is the density of the fluid in pounds per gallon (ppg), depth is the true vertical depth in feet, and 0.052 is a unit conversion factor to units of pounds per square inch (psi). A fluid overbalance is generally performed by placing a fluid, such as a completion brine, into the annulus at a hydrostatic pressure that exceeds the pressure exerted by fluids in the subterranean formation. In this manner, the greater pressure on the wall of the wellbore helps to keep the formation from collapsing into the annular space.

A substance that can bind water molecules is often referred to as a hygroscopic substance. Hygroscopicity is the ability of a substance to attract and hold water molecules from the surrounding environment through either absorption or adsorption. The hygroscopic nature of salt can lower the activity of a salt solution and can help prevent the water in the internal phase from flowing into and contacting the water-sensitive formation, thus minimizing swelling or sloughing of the formation. The hygroscopic nature of other substances, such as glycerol, can also lower the activity of an alcohol-water solution.

There is a continuing need and thus ongoing industry-wide interest in new drilling fluids that provide improved performance while being environmentally-friendly and economical.

It has been discovered that an invert emulsion drilling fluid can include an internal phase of a mixture of a polyol and a salt-water solution. The invert emulsion drilling fluid can provide a more flexible system compared to other invert emulsion drilling fluids. The drilling fluid can also be environmentally friendly.

If the drilling fluid is to be used in a shale formation, then a desirable property of the drilling fluid is a high shale retention value. A shale erosion test is commonly employed to determine the ability of a drilling fluid and/or the additives therein to prevent a shale formation from eroding. Such erosion, when encountered in actual field conditions in a borehole, and as noted above, can lead to problems ranging from sloughing, to a washout, to a complete collapse of the borehole. As used herein, the “shale retention” test is performed as follows. The drilling fluid is mixed. A portion of a specified shale formation is crushed and ground into particles that passed through a 5 mesh screen but are retained on a 10 mesh screen. 30 grams (g) of the ground shale and 1 barrel (350 mL) of the drilling fluid are placed into a pint jar (350 ml). The shale/drilling fluid mixture is then rolled on a rolling apparatus at a temperature of 150° F. (65.5° C.) for 16 hours. The drilling fluid is then screened through the 10 mesh screen and the retained solids are washed, dried, and weighed. The percent of erosion is calculated based on the weight loss of the ground shale, corrected for the moisture content of the original sample. The shale erosion value minus 100% corresponds to the shale retention value. A shale retention value of greater than or equal to 95% indicates a high shale retention value.

Any of the ingredients included in the drilling fluid can be inherently biodegradable. Inherent biodegradability refers to tests which allow prolonged exposure of the test substance to microorganisms. As used herein, a substance with a biodegradation rate of >20% is regarded as “inherently primary biodegradable.” A substance with a biodegradation rate of >70% is regarded as “inherently ultimate biodegradable.” A substance passes the inherent biodegradability test if the substance is either regarded as inherently primary biodegradable or inherently ultimate biodegradable. As used herein, the “inherent biodegradability” of a substance is tested in accordance with OECD guidelines, using the 302 B-1992 Zahn-Wellens test as follows. The test substance, mineral nutrients, and a relatively large amount of activated sludge in aqueous medium is agitated and aerated at 20° C. to 25° C. in the dark or in diffuse light for up to 28 days. A blank control, containing activated sludge and mineral nutrients but no test substance, is run in parallel. The biodegradation process is monitored by determination of DOC (or COD(2)) in filtered samples taken at daily or other time intervals. The ratio of eliminated DOC (or COD), corrected for the blank, after each time interval, to the initial DOC value is expressed as the percentage biodegradation at the sampling time. The percentage biodegradation is plotted against time to give the biodegradation curve.

According to an embodiment, an invert emulsion drilling fluid comprises: an external phase, wherein the external phase comprises a hydrocarbon liquid; an internal phase, wherein the internal phase comprises: (i) a polyol; and (ii) a solution comprising a water-soluble salt and water.

According to another embodiment, a method of using the invert emulsion drilling fluid comprises: introducing the drilling fluid into a portion of a subterranean formation.

The discussion of preferred embodiments regarding the drilling fluid or any ingredient in the drilling fluid, is intended to apply to the composition embodiments and the method embodiments. Any reference to the unit “gallons” means U.S. gallons.

The drilling fluid is an invert emulsion. The invert emulsion includes only one external phase and at least one internal phase. The external phase comprises a hydrocarbon liquid. The external phase can include dissolved materials or undissolved solids. Preferably, the hydrocarbon liquid is selected from the group consisting of: a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof. Crude oil can be separated into fractional distillates based on the boiling point of the fractions in the crude oil. An example of a suitable fractional distillate of crude oil is diesel oil. A commercially-available example of a fatty acid ester is PETROFREE® ESTER base fluid, marketed by Halliburton Energy Services, Inc. The saturated hydrocarbon can be an alkane or paraffin. Preferably, the saturated hydrocarbon is a paraffin. The paraffin can be an isoalkane (isoparaffin), a linear alkane (paraffin), or a cyclic alkane (cycloparaffin). An example of an alkane is BAROID ALKANE™ base fluid, marketed by Halliburton Energy Services, Inc. Examples of suitable paraffins include, but are not limited to: BIO-BASE 360® (an isoalkane and n-alkane); BIO-BASE 300™ (a linear alkane); BIO-BASE 560® (a blend containing greater than 90% linear alkanes); and ESCAID 110™ (a mineral oil blend of mainly alkanes and cyclic alkanes). The BIO-BASE liquids are available from Shrieve Chemical Products, Inc. in The Woodlands, Tex. The ESCAID liquid is available from ExxonMobil in Houston, Tex. The unsaturated hydrocarbon can be an alkene, alkyne, or aromatic. Preferably, the unsaturated hydrocarbon is an alkene. The alkene can be an isoalkene, linear alkene, or cyclic alkene. The linear alkene can be a linear alpha olefin or an internal olefin. An example of a linear alpha olefin is NOVATEC™, available from M-I SWACO in Houston, Tex. Examples of internal olefins include, ENCORE® drilling fluid and ACCOLADE® drilling fluid, marketed by Halliburton Energy Services, Inc.

The drilling fluid includes an internal phase. The internal phase comprises a polyol. The polyol can be a liquid. The polyol can be biodegradable. The polyol is an alcohol that includes more than two hydroxyl groups. Preferably, the polyol lowers the activity of the internal phase. Preferably, the polyol is water soluble. As used herein, the term “soluble” means that more than 1 part of the substance dissolves in 5 parts of water. Preferably, the polyol is a glycerol. The glycerol can be polyglycerol. One of the advantages to using glycerol compared to polyglycerol is that glycerol is less expensive than polyglycerol. The polyol can be in a concentration of about 50% to about 70% by volume of the internal phase.

The internal phase also includes a solution comprising a water-soluble salt and water. Of course, the internal phase can also include more than one salt in the solution of the salts and water. The water can be freshwater. The salt(s) can include combinations of ions selected from the group consisting of Li⁺, Na⁺, K⁺, Rb⁺, Cs⁺, Mg⁺², Ca⁺², Fe⁺², Fe⁺³, F⁻, Cl⁻, CH₃COO⁻, CHOO⁻, SO₄⁻², HCO₃⁻, PO₄⁻³. According to certain embodiments, the salt is neither toxic nor reactive. Some ions that can be considered to be toxic or reactive can include without limitation Sr⁺², Ba⁺², Br⁻, I⁻, and NO₃⁻. By way of example, the salt can be selected from the group consisting of sodium chloride, calcium chloride, potassium chloride, magnesium chloride, potassium acetate, potassium formate, magnesium sulfate, and combinations thereof. The salt and the ions that make up the salt can be selected such that the salt has a desired solubility in the water. For example, some salts may be more soluble than others. The water-soluble salts can be in a total concentration in the range of about 0.1% to about 40% by weight of the water, preferably about 0.1% to about 30% by weight of the water.

It is to be understood that the internal phase can include other ingredients in addition to the polyol, the water-soluble salt, and the water. The other ingredients can be a liquid, solutes dissolved in a solvent, or undissolved solids. The internal phase can be in a concentration in the range of about 0.5% to about 60% by volume of the external phase. The internal phase can also be in a concentration of about 15% to about 45% by volume of the external phase.

The drilling fluid can further include a suspending agent. In an embodiment, the suspending agent is selected such that the invert emulsion is stable. For example, any undissolved solids in the drilling fluid do not settle to the bottom of the fluid. In an embodiment, the suspending agent is in a concentration of at least 1 pounds per barrel (ppb) of the drilling fluid. The suspending agent can also be in a concentration in the range of about 0.25 to about 15 ppb of the drilling fluid. In an embodiment, the suspending agent is in a concentration in the range of about 2 to about 8 ppb of the drilling fluid.

The drilling fluid can further include a viscosifier. The viscosifier can be selected from the group consisting of an inorganic viscosifier, fatty acids, and combinations thereof. Commercially-available examples of a suitable viscosifier include, but are not limited to, RHEMOD L®, TAU-MOD®, RM-63™, and combinations thereof, marketed by Halliburton Energy Services, Inc. According to an embodiment, the viscosifier is in a concentration of at least 0.5 ppb of the drilling fluid. The viscosifier can also be in a concentration in the range of about 0.5 to about 20 ppb, alternatively of about 0.5 to about 10 ppb, of the drilling fluid.

The drilling fluid can further include an emulsifier. The emulsifier can be selected from the group consisting of tall oil-based fatty acid derivatives, vegetable oil-based derivatives, and combinations thereof. Commercially-available examples of a suitable emulsifier include, but are not limited to, EZ MUL® NT, INVERMUL® NT, LE SUPERMUL ®, and combinations thereof, marketed by Halliburton Energy Services, Inc. According to an embodiment, the emulsifier is in at least a sufficient concentration such that the drilling fluid maintains a stable invert emulsion. According to yet another embodiment, the emulsifier is in a concentration of at least 3 ppb of the drilling fluid. The emulsifier can also be in a concentration in the range of about 3 to about 20 ppb of the drilling fluid.

The drilling fluid can further include an emulsifier activator. The emulsifier activator aids the emulsifier in creating a stable invert emulsion. The emulsifier activator can be a base, such as lime. According to an embodiment, the emulsifier activator is in a concentration of at least 0.5 ppb of the drilling fluid. The emulsifier activator can also be in a concentration in the range of about 0.5 to about 3 ppb of the drilling fluid.

The drilling fluid can further include a weighting agent. The weighting agent can be selected from the group consisting of barite, hematite, manganese tetroxide, calcium carbonate, and combinations thereof. According to an embodiment, the weighting agent is not an organophilic clay or organophilic lignite. Commercially-available examples of a suitable weighting agent include, but are not limited to, BAROID®, BARACARB®, BARODENSE®, MICROMAX™, and combinations thereof, marketed by Halliburton Energy Services, Inc. According to an embodiment, the weighting agent is in a concentration of at least 10 ppb of the drilling fluid. The weighting agent can also be in a concentration in the range of about 10 to about 500 ppb of the drilling fluid. According to another embodiment, the weighting agent is in at least a sufficient concentration such that the drilling fluid has a density in the range of about 9 to about 20 pounds per gallon (ppg) (about 1.078 to about 2.397 kilograms per liter “kg/L”). Preferably, the weighting agent is in at least a sufficient concentration such that the drilling fluid has a density in the range of about 9 to about 18 ppg (about 1.1 to about 2.4 kg/L).

The drilling fluid can further include a fluid loss additive. The fluid loss additive can be selected from the group consisting of methylestyrene-co-acrylate, a substituted styrene copolymer, and combinations thereof. Commercially-available examples of a suitable fluid loss additive include, but are not limited to, ADAPTA®, marketed by Halliburton Energy Services, Inc. According to an embodiment, the fluid loss additive is in at least a sufficient concentration such that the drilling fluid has an API fluid loss of less than 8 mL/30 min at a temperature of 300° F. (149° C.) and a pressure differential of 500 psi (3.4 megapascals “MPa”). The fluid loss additive can also be in at least a sufficient concentration such that the drilling fluid has an API fluid loss of less than 5 mL/30 min at a temperature of 300° F. (149° C.) and a pressure differential of 500 psi (3.4 MPa). According to another embodiment, the fluid loss additive is in a concentration of at least 0.5 ppb of the drilling fluid. The fluid loss additive can also be in a concentration in the range of about 0.5 to about 10 ppb of the drilling fluid.

The drilling fluid can also include a friction reducer. Commercially-available examples of a suitable friction reducer include, but are not limited to, TORQ-TRIM® II, graphitic carbon, and combinations thereof, marketed by Halliburton Energy Services, Inc. The friction reducer can be in a concentration of at least 0.5 ppb of the drilling fluid. In an embodiment, the friction reducer is in a concentration in the range of about 0.5 to about 5 ppb of the drilling fluid.

According to certain embodiments, the drilling fluid does not include an organophilic clay or organophilic lignite. According to other embodiments, the drilling fluid contains organophilic clay, organophilic lignite, or combinations thereof. The drilling fluid can contain the organophilic clay or lignite at a concentration up to 1 pounds per barrel (ppb) of the drilling fluid. The drilling fluid can also contain the organophilic clay or lignite at a concentration in the range of 0 to about 20 ppb, alternatively of 0 to about 10 ppb, or alternatively from about 3 to about 8 ppb of the drilling fluid.

According to an embodiment, the drilling fluid provides a shale retention value of greater than 90%, in another embodiment greater than 95%, when tested on a portion of a shale formation at a temperature of 150° F. (65.5° C.) for 16 hours. According to another embodiment, the drilling fluid has an activity less than or equal to the amount needed to provide a shale retention value of greater than 90%, in another embodiment greater than 95%, when tested on a portion of a shale formation at a temperature of 150° F. (65.5° C.) for 16 hours. The polyol can be selected and in at least a sufficient concentration such that the drilling fluid has an activity less than or equal to the amount needed to provide a shale retention value of greater than 90%, in another embodiment greater than 95%. The salt can be selected and in at least a sufficient concentration such that the drilling fluid has an activity less than or equal to the amount needed to provide a shale retention value of greater than 90%, in another embodiment greater than 95%. According to certain embodiments, both the polyol and the salt are selected and in at least a sufficient concentration such that the activity of the internal phase is lowered sufficiently to provide a shale retention value of greater than 90%, in another embodiment greater than 95%. The portion of the shale formation can be obtained from the Pierre shale formation (located east of the Rocky Mountains in the Great Plains, from North Dakota to New Mexico, U.S.A.) or the London clay formation (located southeast of England).

According to the method embodiments, the methods include the step of introducing the drilling fluid into at least a portion of a subterranean formation. The drilling fluid can be introduced using a pump. The drilling fluid can be mixed with a suitable mixing apparatus prior to the step of introducing. Preferably, the at least a portion of the subterranean formation is a water-sensitive formation. More preferably, the at least a portion of the subterranean formation is a shale formation. The methods can further include drilling a wellbore that penetrates the subterranean formation using the drilling fluid. The drilling fluid can be in a pumpable state before and during introduction into the subterranean formation. The well can be an oil, gas, water, or injection well. The subterranean formation can include an annulus. The step of introducing the drilling fluid can include introducing the drilling fluid into a portion of the annulus.

The methods can further include the step of introducing a spacer fluid into the at least a portion of the subterranean formation after the step of introducing the drilling fluid. The methods can also further include the step of introducing a cement composition into the at least a portion of the subterranean formation. As used herein, a “cement composition” is a mixture of at least cement and water, and possibly additives. As used herein, the term “cement” means an initially dry substance that, in the presence of water, acts as a binder to bind other materials together. An example of cement is Portland cement. The step of introducing the cement composition can be performed after the step of introducing the drilling fluid. If the methods also include the step of introducing a spacer fluid, then the step of introducing the cement composition can be performed after the step of introducing the spacer fluid. The step of introducing the cement composition can be for the purpose of at least one of the following: well completion; foam cementing; primary or secondary cementing operations; well-plugging; and gravel packing. The cement composition can be in a pumpable state before and during introduction into the subterranean formation. The step of introducing can include introducing the cement composition into the well. According to another embodiment, the subterranean formation is penetrated by a well and the well includes an annulus. According to this other embodiment, the step of introducing can include introducing the cement composition into a portion of the annulus.

The method embodiments can also include the step of allowing the cement composition to set. The step of allowing can be performed after the step of introducing the cement composition into the subterranean formation. The method can include the additional steps of perforating, fracturing, or performing an acidizing treatment, after the step of allowing.

The exemplary fluids and additives disclosed herein may directly or indirectly affect one or more components or pieces of equipment associated with the preparation, delivery, recapture, recycling, reuse, and/or disposal of the disclosed fluids and additives. For example, the disclosed fluids and additives may directly or indirectly affect one or more mixers, related mixing equipment, mud pits, storage facilities or units, fluid separators, heat exchangers, sensors, gauges, pumps, compressors, and the like used to generate, store, monitor, regulate, and/or recondition the exemplary fluids and additives. The disclosed fluids and additives may also directly or indirectly affect any transport or delivery equipment used to convey the fluids and additives to a well site or downhole such as, for example, any transport vessels, conduits, pipelines, trucks, tubulars, and/or pipes used to fluidically move the fluids and additives from one location to another, any pumps, compressors, or motors (e.g., topside or downhole) used to drive the fluids and additives into motion, any valves or related joints used to regulate the pressure or flow rate of the fluids, and any sensors (i.e., pressure and temperature), gauges, and/or combinations thereof, and the like. The disclosed fluids and additives may also directly or indirectly affect the various downhole equipment and tools that may come into contact with the fluids and additives such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A method of using an invert emulsion drilling fluid comprising:
introducing the drilling fluid into at least a portion of a subterranean formation, wherein the drilling fluid comprises:
(A) an external phase, wherein the external phase comprises a hydrocarbon liquid;
(B) an internal phase, wherein the internal phase comprises:
(i) a polyol; and
(ii) a solution comprising a water-soluble salt and water.

2. The method according to claim 1, wherein the hydrocarbon liquid is selected from the group consisting of: a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof.

3. The method according to claim 1, wherein the polyol comprises a glycerol.

4. The method according to claim 3, wherein the glycerol is polyglycerol.

5. The method according to claim 1, wherein the polyol is in a concentration of about 50% to about 70% by volume of the internal phase.

6. The method according to claim 1, wherein the solution comprises more than one salt.

7. The method according to claim 1, wherein the salt comprises ions selected from the group consisting of Li⁺, Na⁺, K⁺, Rb⁺, Cs⁺, Mg⁺², Ca⁺², Fe⁺², Fe⁺³, F⁻, Cl⁻,CH₃COO⁻, CHOO⁻, SO₄⁻², HCO₃⁻, PO₄⁻³ and combinations thereof.

8. The method according to claim 7, wherein the salt is selected from the group consisting of sodium chloride, calcium chloride, potassium chloride, magnesium chloride, potassium acetate, potassium formate, magnesium sulfate, and combinations thereof.

9. The method according to claim 1, wherein the salt is neither toxic nor reactive.

10. The method according to claim 1, wherein the salt is in a concentration in the range of about 0.1% to about 40% by weight of the water.

11. The method according to claim 1, wherein the water is freshwater.

12. The method according to claim 1, wherein the internal phase is in a concentration in the range of about 0.5% to about 60% by volume of the external phase.

13. The method according to claim 1, wherein the drilling fluid provides a shale retention value of greater than 90%, when tested on a portion of a shale formation at a temperature of 150° F. for 16 hours.

14. The method according to claim 1, wherein the drilling fluid has an activity less than or equal to the amount needed to provide a shale retention value of greater than 90%, when tested on a portion of a shale formation at a temperature of 150° F. for 16 hours.

15. The method according to claim 1, wherein the polyol and the salt are selected and in at least a sufficient concentration such that the activity of the internal phase is lowered sufficiently to provide a shale retention value of greater than 90%, when tested on a portion of a shale formation at a temperature of 150° F. for 16 hours.

16. The method according to claim 1, further comprising drilling a wellbore that penetrates the subterranean formation using the drilling fluid.

17. The method according to claim 1, wherein the at least a portion of the subterranean formation is a water-sensitive formation.

18. The method according to claim 17, wherein the water-sensitive formation is a shale formation.

19. The method according to claim 1, further comprising mixing the treatment fluid with a mixing apparatus.

20. The method according to claim 1, wherein the step of introducing comprises pumping the drilling fluid into the subterranean formation.

21. An invert emulsion drilling fluid comprising:
an external phase, wherein the external phase comprises a hydrocarbon liquid;
an internal phase, wherein the internal phase comprises:
(i) a polyol; and
(ii) a solution comprising a water-soluble salt and water.
